(19) United States
(12) Patent Application Publication
(10) Pub. No.: US 2014/0202623 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/954,947

(22) Filed: Jul. 30, 2013

(30) Foreign Application Priority Data
Jan. 24, 2013 (TW) 102102573

(51) Int. Cl. B29D 99/00

(52) U.S. Cl. CPC B29D 99/0032
USPC 156/187; 156/446

(57) ABSTRACT

An apparatus includes a film chemical treatment device, a loading plate, a processing device, a mounting device, and a cutting device. The film chemical treatment device forms a number of silica nanoparticles in the polymer grids of an original molding film to obtain a preprocessed molding film. The loading plate loads the preprocessed molding film having a preprocessed molding surface opposite to the loading plate. The processing device forms a number of molding patterns on the preprocessed molding surface to obtain a molding film with a molding surface. The mounting device winds the molding film around a circumferential surface of a main body. The cutting device cuts the molding film. The molding film and the main body cooperatively form a molding roller.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

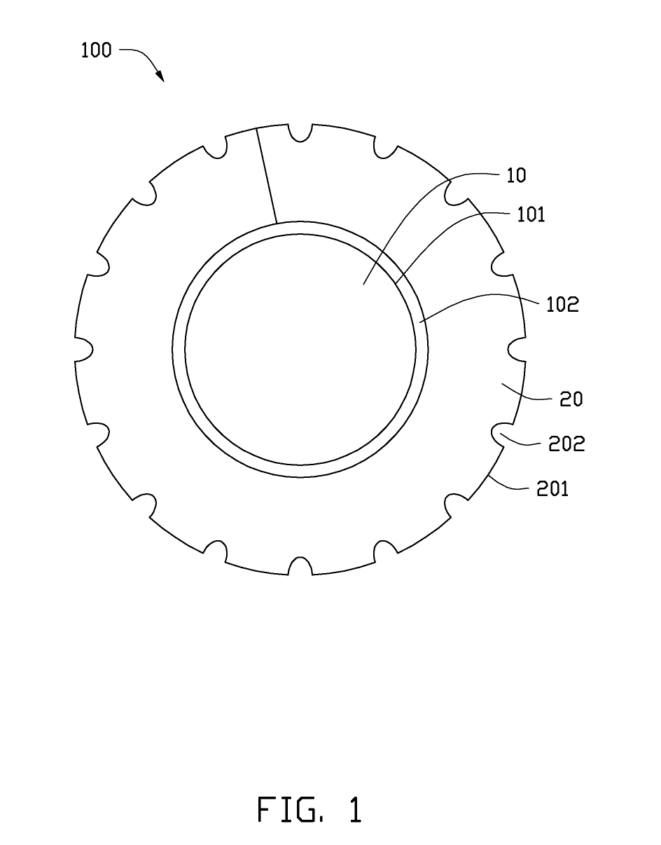

FIG. 1 illustrates a molding roller 100 in accordance with a first exemplary embodiment. The molding roller 100 includes a cylindrical main body 10 and a ring-shaped molding film 20. The main body 10 includes a circumferential surface 101, and can be made of stainless steel or other metals. The circumferential surface 101 is coated with an adhesive glue 102.

The molding film 20 is wound around and fixed to the circumferential surface 101 of the main body 10 via the adhesive glue 102. The molding film 20 includes a molding surface 201 opposite to the main body 10. The molding surface 201 includes a number of molding patterns 202. In the first embodiment, the molding patterns 202 are micro striped grooves. In other embodiments, the molding patterns 202 also can be micro-dots, striped protrusions or micro domes.

The molding film 20 is made of flexible polymer material consisting of polymer resin and a number of silica nanoparticles formed in polymer grids of the polymer resin. In the first embodiment, the polymer resin is polydimethylsiloxane (PDMS) resin, and the silica nanoparticles are formed by sol-gel method.

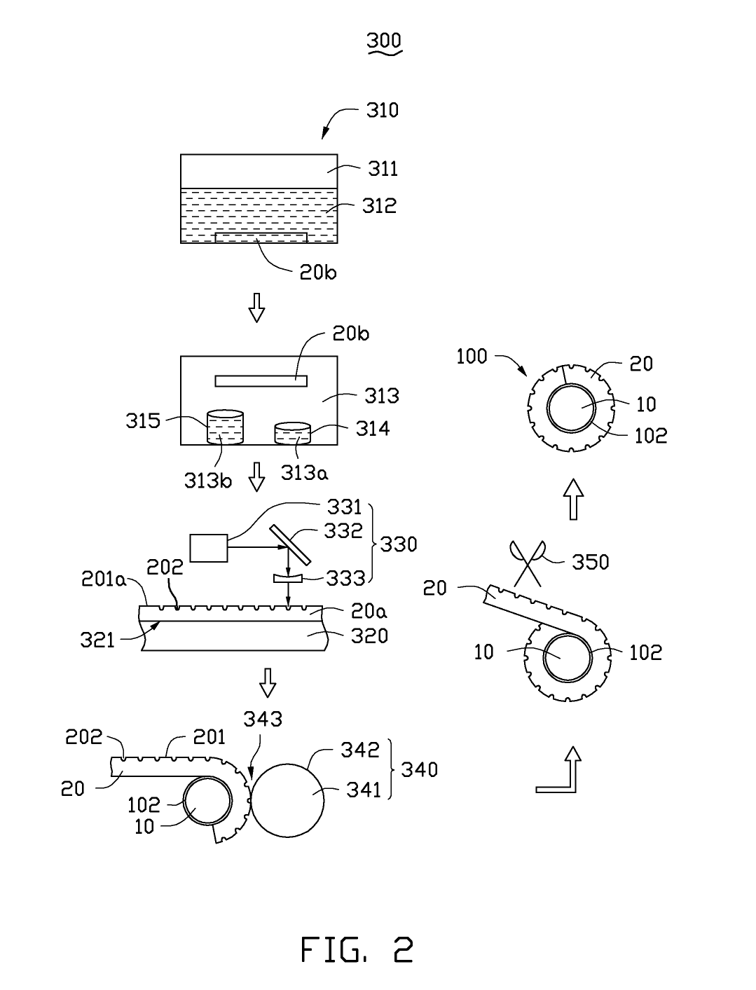

FIG. 2 illustrates an apparatus 300 for manufacturing the molding roller 100 according to a second exemplary embodiment. The apparatus 300 includes a film chemical treatment device 310, a loading plate 320, a processing device 330, a mounting device 340, and a cutting device 350.

The film chemical treatment device 310 is used for chemically processing an original film 20b to obtain a preprocessed molding film 20a. In this embodiment, the original film 20b is made of PDMS resin, the film chemical treatment device 310 is used for forming a number of silica nanoparticles in the polymer grids of the PDMS resin. The film chemical treatment device 310 includes a receiving chamber 311 and a vacuum chamber 313. A reaction liquid 312 (such as tetraethoxy silane, TEOS) is received in the receiving chamber 311. The original film 20b is immersed in the reaction liquid 312 for a first predetermined period until the reaction liquid 312 penetrates the original film 20b, then the original film 20b is taken out from the receiving chamber 311, and the reaction liquid 312 covered on the original film 20b is removed.

A first container 314 and a second container 315 are received in the vacuum chamber 313. The first container 314 is used for receiving an alkaline catalyst 313a, and the second container 315 is used for receiving deionized water 313b. In this embodiment, the alkaline catalyst 313a is 95% 2-amino-2-methyl-propanol solution (AMP-95), and the volume ratio of the alkaline catalyst 313a to the deionized water 313b is 1:5. The penetrated original film 20b is received in the vacuum chamber 313, and is positioned upon the first container 314 and the second container 315. When the temperature of the vacuum chamber 313 is gradually increased, the alkaline catalyst 313a and the deionized water 313b are vaporized to arrive at the penetrated original film 20b, so as to promote the original film 20b condensation react with the reaction liquid 312, and the growth rate of the silica nanoparticles is increased to obtain the preprocessed molding film 20a. In this embodiment, the PH value of the alkaline catalyst 313a is 8-10.

The loading plate 320 is used for loading the preprocessed molding film 20a. The preprocessed molding film 20a has a planar preprocessed surface 201a opposite to the loading plate 320. The loading plate 320 has a planar loading surface 321. Two opposite ends of the preprocessed molding film 20a are fixed to the planar loading surface 321 using an adhesive glue (not shown) or other fixing means.

The processing device 330 is used for forming a number of molding patterns 202 on the planar preprocessed molding surface 201a, and thus the molding film 20 having the molding surface 201 are obtained. In this embodiment, the processing device 330 includes a laser emitter 331, a reflector 332, and a converging lens 333. The laser emitter 331 is used for emitting laser rays. The transmitting direction of the laser rays is substantially parallel to the preprocessed molding surface 201a. The reflector 332 is used for changing the transmitting direction of the laser rays and reflecting the laser rays to the converging lens 333. The converging lens 333 converges the laser rays to the preprocessed molding surface 201a. In other embodiments, the reflector 332 and the converging lens 333 can be omitted, and the transmitting direction of the laser rays should be substantially perpendicular to the preprocessed molding surface 201a. If the molding patterns are V-shaped grooves, and the processing device 330 may include a diamond knife having a V-shaped blade.

The mounting device 340 is used for mounting the molding film 20 on the circumferential surface 101 of the main body 10, and includes an auxiliary roller 341 having a smooth rolling surface 342. The auxiliary roller 341 is at a predetermined distance from the main body 10 to form a molding channel 343. The auxiliary roller 341 and the main body 10 are rotated in opposite directions of each other. The circumferential surface 101 is coated with the adhesive glue 102. An end of the molding film 20 is adhered on the circumferential surface 101, then the main body 10 and the auxiliary roller 341 are rotated to make the molding film 20 pass through the molding channel 343, and thus the molding film 20 is wound around and fixed to the circumferential surface 101 via the adhesive glue 102.

The cutting device 350 cuts the molding film 20.

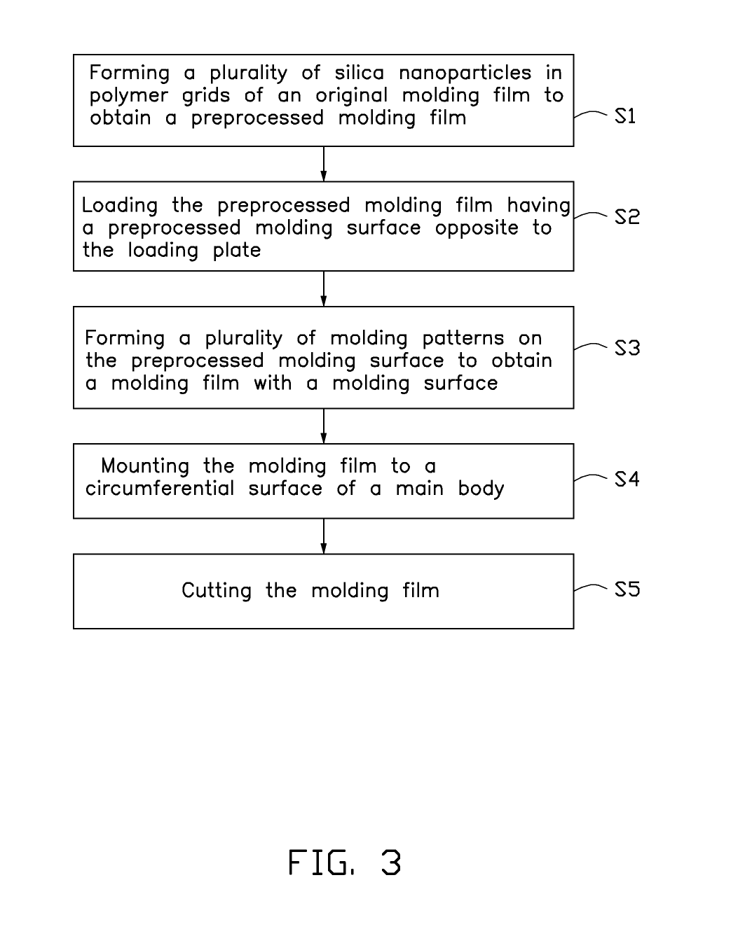

FIG. 3 illustrates a method for manufacturing the molding roller 100 using the apparatus 300, according to a third exemplary embodiment. The method includes the following steps.

In step S1, a number of silica nanoparticles are formed in the polymer grids of the original molding film 20b using the film chemical treatment device 310 to obtain the preprocessed molding film 20a.

In step S2, the preprocessed molding film 20a is positioned on the loading plate 320.

In step S3, the molding patterns 202 are formed on the preprocessed molding surface 201a using the processing device 330 to obtain the molding surface 201 with the molding film 20.

In step S4, the molding film 20 is separated from the loading plate 320 and is wound around and fixed to the circumferential surface 101 of the main body 10 using the mounting device 340.

In step S5, the molding film 20 is cut.

In other embodiments, the step S4 and the step S5 also can be interchanged.

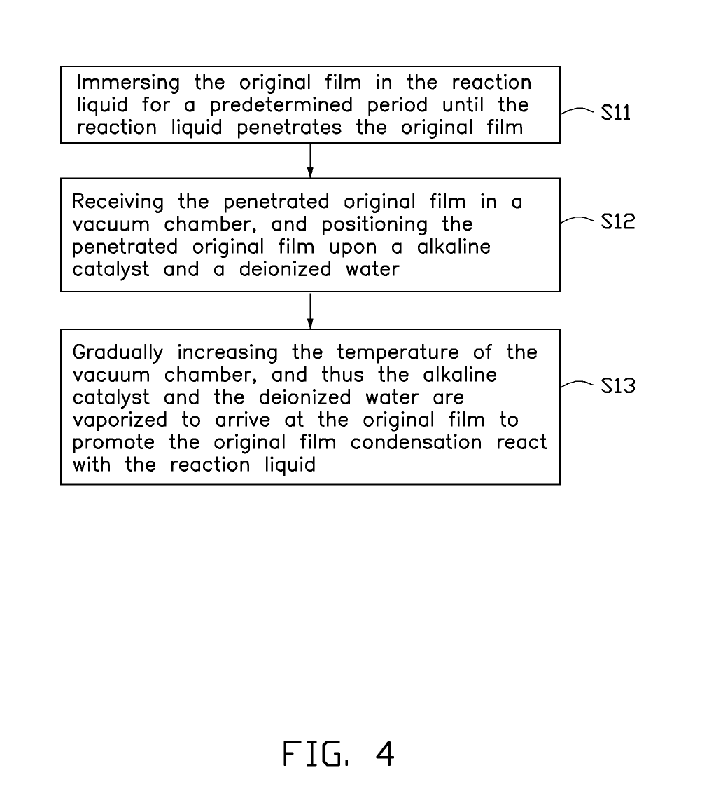

FIG. 4 illustrates that the step Si further includes the following sub-steps.

In step S11, the original film 20b is immersed in the reaction liquid for a predetermined period until the reaction liquid 312 penetrates the original film 20b.

In step S12, the penetrated original film 20b is received in the vacuum chamber 313, and is positioned above the alkaline catalyst 313a and the deionized water 313b.

In step S13, the temperature of the vacuum chamber 313 is gradually increased, the alkaline catalyst 313a and the deionized water 313b are vaporized to arrive at the original film 20b, so as to promote the original film 20b condensation react with the reaction liquid 312, and the growth rate of the silica nanoparticles is increased to obtain the preprocessed molding film 20a.

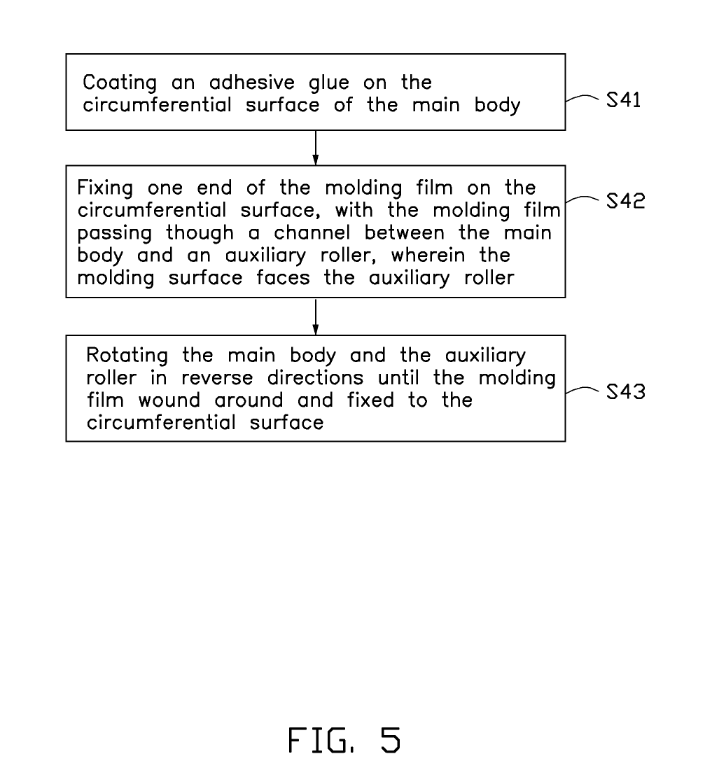

FIG. 5 illustrates that the step S4 further includes the following sub-steps.

In step S41, the circumferential surface 101 is coated with the adhesive glue 102.

In step S42, an end of the molding film 20 is adhered on the circumferential surface 101, and the molding surface 201 faces the auxiliary roller 341.

In step S43, the main body 10 and the auxiliary roller 341 are rotated to make the molding film 20 pass through the molding channel 343 until the molding film 20 is wound around the circumferential surface 101.

By employing the apparatus 300 and the above described method, it is easier for the processing device 330 to machine the molding patterns 202 on the planar preprocessed molding surface 201a of the preprocessed molding film 20a relative to on a curved surface of the metallic roller in the related art, therefore, the machining efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An apparatus for manufacturing a molding roller, comprising:
a film chemical treatment device configured for forming a plurality of silica nanoparticles in the polymer grids of an original molding film to obtain a preprocessed molding film;
a loading plate configured for loading the preprocessed molding film having a preprocessed molding surface opposite to the loading plate;
a processing device configured for forming a plurality of molding patterns on the preprocessed molding surface to obtain a molding film with a molding surface;
a mounting device configured for mounting the molding film to a circumferential surface of a main body until the molding film is wound around the circumferential surface; and
a cutting device configured for cutting the molding film, and the molding film and the main body cooperatively forming the molding roller.

2. The apparatus of claim 1, wherein the film chemical treatment device comprises a receiving chamber and a vacuum chamber, the receiving chamber is configured for receiving a reaction liquid, the original film is received in the reaction liquid for a predetermined period until the reaction liquid penetrates the original film, the vacuum chamber is configured for receiving an alkaline catalyst and an adeionized water; when the penetrated original film is received in the vacuum chamber, and is positioned above the alkaline catalyst and the adeionized water, the temperature of the vacuum chamber is gradually increased, the alkaline catalyst and the adeionized water arrived at the penetrated original film to promote the original film condensation reacts with the reaction liquid, and thus the silica nanoparticles are formed in the polymer grids of the original molding film.

3. The apparatus of claim 1, wherein the processing device comprises a laser emitter, a reflector, and a converging lens, the laser emitter emits laser rays, the transmitting direction of the laser rays is substantially parallel to the preprocessed molding surface, the reflector changes the transmitting direction of the laser rays and reflecting the laser rays to the converging lens, the converging lens converges the laser rays to the preprocessed molding surface.

4. The apparatus of claim 1, wherein the mounting device comprises an auxiliary roller spaced a predetermined distance from the main body to form a channel between the auxiliary roller and the main body.

5. A method for manufacturing a molding roller, comprising:
forming a plurality of silica nanoparticles in polymer grids of an original molding film to obtain a preprocessed molding film;
loading the preprocessed molding film having a preprocessed molding surface opposite to the loading plate;
forming a plurality of molding patterns on the preprocessed molding surface to obtain a molding film with a molding surface;
mounting the molding film to a circumferential surface of a main body; and
cutting the molding film.

6. The method of claim 5, wherein the step of forming a plurality of silica nanoparticles in the polymer grids of an original molding film to obtain a preprocessed molding film further comprises:
immersing the original film in a reaction liquid for a predetermined period until the reaction liquid penetrates the original film;
receiving the penetrated original film in a vacuum chamber, and positioning the penetrated original film over an alkaline catalyst and a deionized water; and
gradually increasing the temperature of the vacuum chamber, such that the alkaline catalyst and the deionized water are vaporized to arrive at the original film to promote the original film condensation react with the reaction liquid, the growth rate of the silica nanoparticles is increased to obtain the preprocessed molding film.

7. The method of claim 6, wherein the volume ratio of the alkaline catalyst to the deionized water is about 1:5.

8. The method of claim 6, wherein the original film is made of polydimethylsiloxane resin, and the reaction liquid is tetraethoxy silane.

9. The method of claim 5, wherein the step of mounting the molding film on a circumferential surface of a main body further comprises:
coating an adhesive glue on the circumferential surface of the main body;
fixing an end of the molding film on the circumferential surface, with the molding film passing though a channel between the main body and an auxiliary roller, wherein the molding surface faces the auxiliary roller; and
rotating the main body and the auxiliary roller in reverse directions until the molding film wound around and fixed to the circumferential surface.
